(19) United States
(12) Patent Application Publication
(10) Pub. No.: US 2026/0060782 A1
(43) Pub. Date: Mar. 5, 2026

(54) DENTAL MATRIX BAND SYSTEM

(71) Applicant: Rhondium IP Limited, Katikati (NZ)

(72) Inventor: Peter Nicholson, Katikati (NZ)

(73) Assignee: Rhondium IP Limited, Katikati (NZ)

(21) Appl. No.: 19/106,598

(22) PCT Filed: Aug. 25, 2023
(86) PCT No.: PCT/US2023/031199

§ 371 Date: Feb. 25, 2025

(30) Foreign Application Priority Data
Aug. 25, 2022 (NZ) 791810

(51) Int. Cl. A61C 5/85

(52) U.S. Cl. CPC A61C 5/85

(57) ABSTRACT

A dental matrix band system is shown comprising a circumferential matrix band, tensioner assembly, and readily releasable activator. Selective application of opposing lateral forces to the activator serves to facilitate mating and decoupling of the tensioner and applicator and selective application of opposing rotational forces to the applicator serves to tighten and loosen the circumferential matrix band.

### FIELD OF THE INVENTION

This invention relates generally to the field of dentistry and more specifically to the use of dental matrix bands in the restoration of teeth.

### BACKGROUND OF THE INVENTION

Dental matrix bands and the use of matrix band systems are well known and widely utilized in restorative dentistry. The purpose of using matrix bands is to provide a smooth surface against which the dentist can build the missing tooth. The matrix band is also required to tightly hug the natural tooth to prevent the unnecessary formation of ledges.

There are many types of matrix bands available. They are generally made of metal and/or plastic and are sectional or circumferential bands. Plastic matrix bands are thicker than metal matrix bands and this causes problems obtaining tight interproximal contacts. Thus, metal matrices have been popular, especially for posterior teeth.

Circumferential matrix bands have been in use longer than sectional matrix bands. Generally, circumferential matrix bands are used with a retainer. The function of the retainer is to hold the matrix band in place and to hold the tension, i.e., hold the matrix band flush against the tooth, for the duration of the procedure. The circumferential matrix bands are held in place traditionally using a matrix holder, with a “Tofflemire” being the most common way of holding and full circumferential matrix band in place so the dentist can fill the cavity to the appropriate shape.

Many current matrix band retainers are bulky and need to be attached to the matrix band for the duration of the procedure. It is a relatively large object when compared to the amount of space available in the oral cavity. Leaving the retainer in the oral cavity for the duration of the procedure adds to the discomfort experienced by the patient as it hangs out of the mouth. In addition, existing single-use circumferential matrix bands exhibit one or more of the following deficiencies: matrix has poor anatomical shape, hard to tighten, hard to loosen and re-tighten, cannot be used on all quadrants of the mouth, require finger and thumb at the back of the mouth to tighten, the tightening mechanism operated on one end of the band which rotates the band while being tightened, the tightening applicator locks itself onto the retainer when the band is tight requiring it to be loosened to remove the applicator (e.g. Automatrix), the tightening mechanism fractures when strongly tightened, have limited tightening ability, or do not consistently product tight contact points with the adjacent teeth.

### SUMMARY OF THE INVENTION

An object of this invention is to provide a matrix band tensioner which is easy to use and has a removable applicator addressing and avoiding the shortcomings of existing devices from prior art devices. The dental matrix band system for positioning and securing a circumferential matrix band on a tooth in need of restoration comprises: a circumferential matrix band formable into a loop, a tensioner releasably attached to an activator, the tensioner adapted to receive the circumferential matrix band and apply to the circumferential matrix band a force generated by the activator to modify the size of the loop. The tensioner includes a first and a second set of guide ribs each of the sets of guide ribs disposed on opposite sides of the tensioner and positioned to receive one of a first and second prong on the activator and adapted to guide the prong members into position to engage the tensioner. The tensioner further includes a first and a second set of retention members disposed on opposite sides of the tensioner, each of the first and second sets of retention members adapted to address a corresponding camming surface on each of the first and second prongs and seat in a recess adjacent to each of the camming surfaces. The activator generates at least a first lateral force in a first direction, the first lateral force applied to a driver bit and transferred to the first and second prongs to transform the first and second prongs from a first, closed position in secure engagement with the tensioner to a second open position releasing the tensioner from engagement with the tensioner.

### BRIEF DESCRIPTION OF THE DRAWINGS

FIG. 1A is a perspective view of a dental matrix band system according to the present invention applied to a tooth in need of restoration and FIG. 1B is a perspective view of the dental matrix band system of FIG. 1A;

FIG. 2 is a perspective view of the dental matrix band system of FIG. 1A;

FIG. 3 is a side perspective view of a circumferential matrix band tensioner of the matrix band system of FIG. 2;

FIG. 4 is a rear perspective view of the circumferential matrix band tensioner of FIG. 3;

FIG. 5 is a bottom plan view of the circumferential matrix band tensioner of FIG. 3;

FIG. 6 is a second perspective view of the circumferential matrix band tensioner of FIG. 3;

FIG. 7 is a partial section view of the circumferential matrix band tensioner of FIG. 6;

FIG. 8 is a side perspective view of the circumferential matrix band;

FIGS. 9-10 are elevation views of a component of the circumferential matrix band tensioner of FIG. 6;

FIG. 11 is a rear perspective view of a component of the circumferential matrix band tensioner of FIG. 3;

FIG. 12 is an elevation view of a component of the circumferential matrix band tensioner of FIG. 1;

FIGS. 13-14 are elevation views of an applicator according to the present invention;

FIG. 15 is a partial elevation view of the applicator of FIGS. 13-14;

FIGS. 16-17 are elevation views of a second applicator according to the present invention;

FIG. 18 is a partial elevation view of the applicator of FIGS. 16-17; and

FIG. 19 is an elevation view of a component of the applicator of FIGS. 13-15.

### DETAILED DESCRIPTION OF THE DRAWINGS

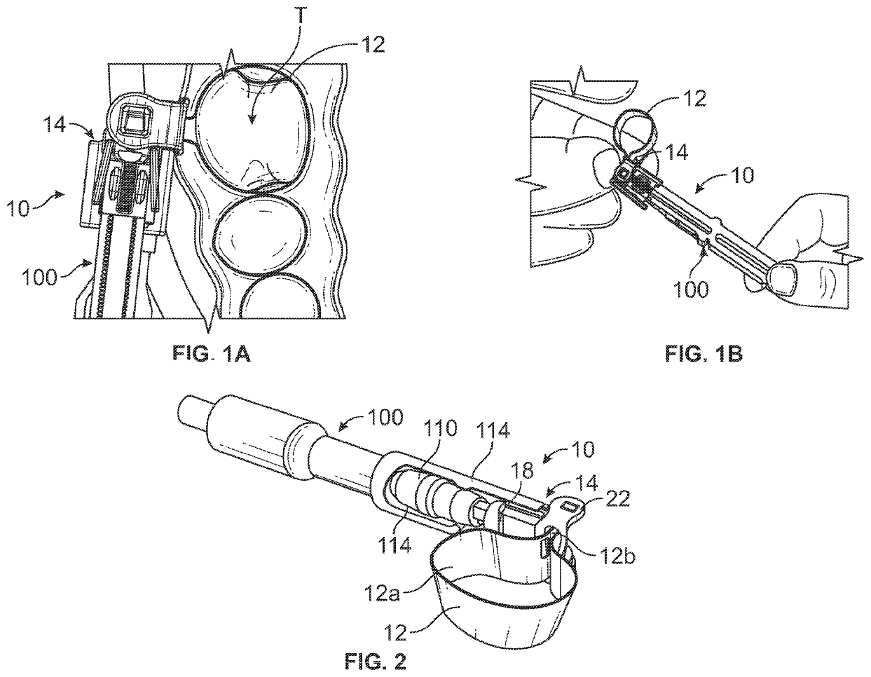

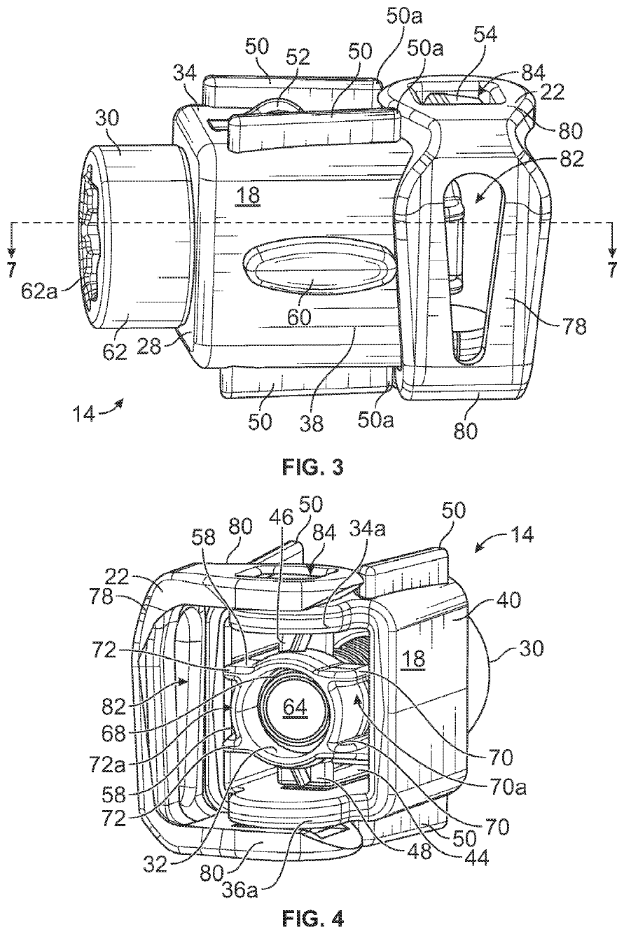

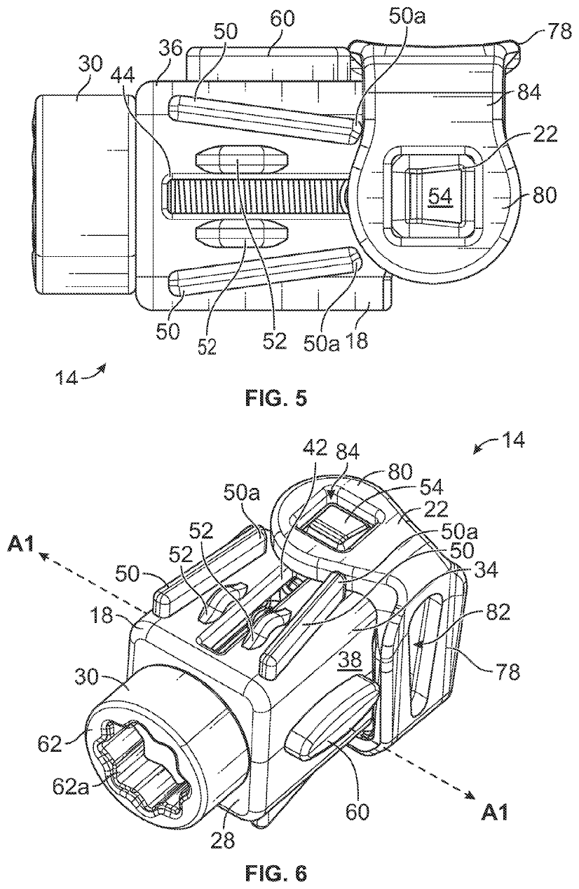

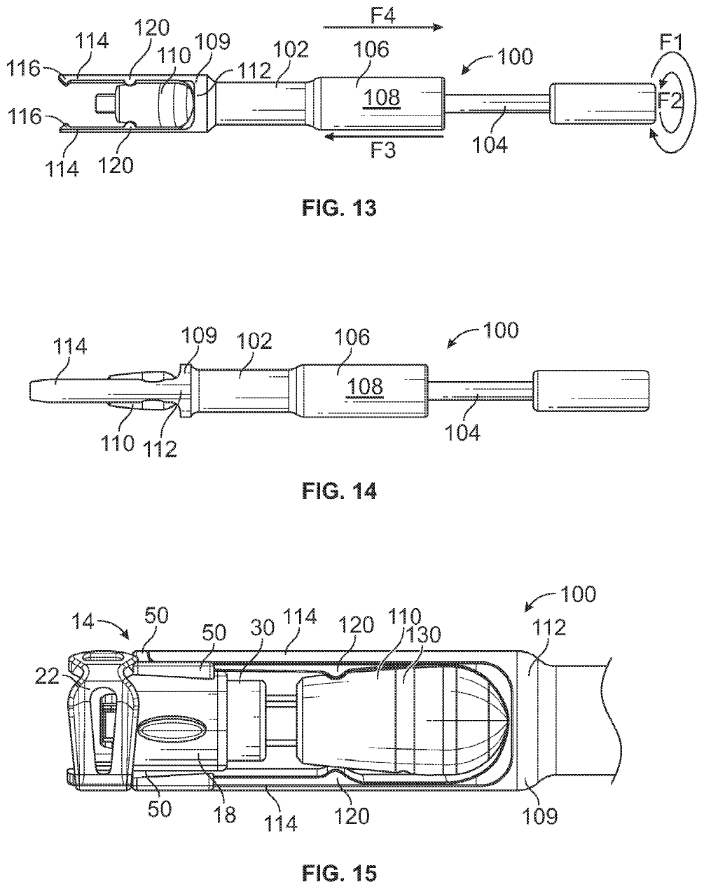

FIGS. 1-19 show embodiments and features of an inventive dental matrix band positioning and tightening system 10. FIGS. 3-12 show embodiments of a tensioner 14 of the dental matrix band application and tightening system 10. FIGS. 13-19 show embodiments of a companion applicator 100 used with the tensioner shown in FIGS. 3-12. Objects of the inventive dental matrix band tightening system include providing a dental matrix band that: (1) is easy to tighten and adjust, (2) does not take up a large amount of space in the oral cavity, (3) does not interfere when the patient bites their teeth together, and (4) maintains the required tension for the duration of the procedure. The inventive system 10 generally comprises a matrix band 12 and a tensioner 14. As seen in FIG. 1, the dental matrix band and tightening system 10 is fitted over a tooth T prepared for restoration, e.g., removal of an old restoration and/or decay using standard dental protocol, and preparation of tooth for the required type of restoration. Once the matrix band 12 is in place, standard dental techniques are used to restore the tooth T.

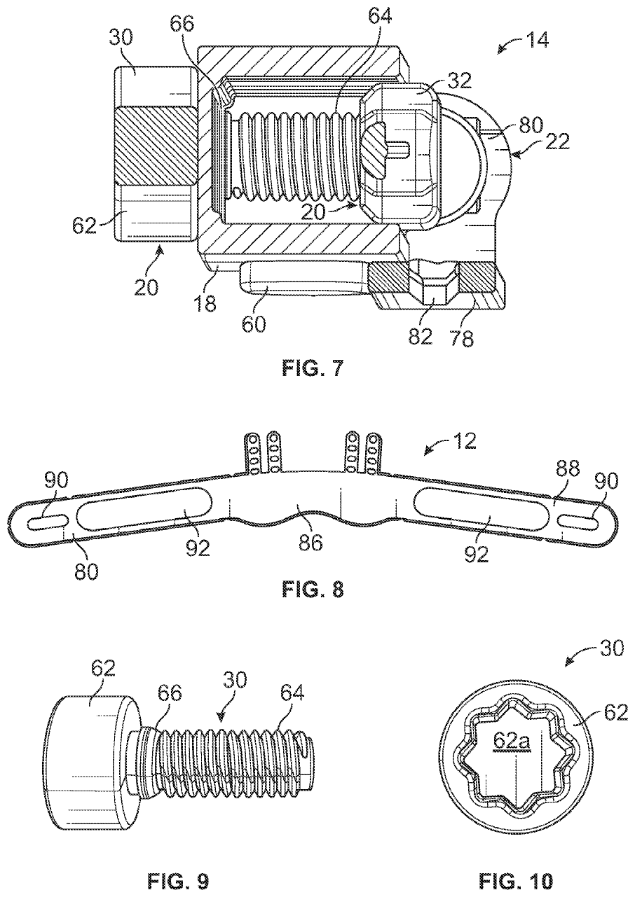

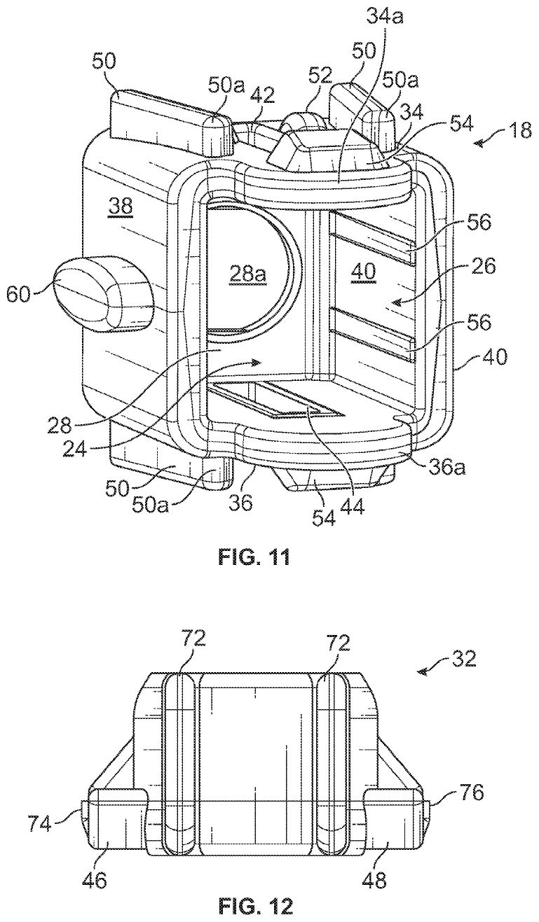

Turning first to FIGS. 3-7, various views of the tensioner 14 are shown. The tensioner 14 generally comprises a capsule 18, actuator 20 (FIG. 7), and swivel member 22. As shown in greater detail in FIG. 11, the capsule 18 is generally cube-shaped with an interior cavity 24, first, open end 26 and an opposing front wall 28. The first, open end 26 and bore 28a in the front wall 28 are configured to receive the actuator 20, with the actuator comprising a screw 30 and nut 32 threaded onto the screw and configured to travel through the interior cavity 24. The capsule 18 is further defined by a top wall 34 and opposing bottom wall 36, and first and second opposing sidewalls 38, 40. The top wall 34 and bottom wall 36 each include an aligned slot 42, 44 extending through the width from the exterior surfaces into the interior cavity 24. Lateral lugs 46, 48 on the nut 32 are received by the corresponding slots 42, 44 to participate in securing the nut 32 within the interior cavity 24 and guiding the nut 32 as it travels through the interior cavity 24.

The exterior surfaces of the top wall 34 and bottom wall 36 further comprise a plurality of protrusions 50 and 52 used as guides and securing members for attachment of a companion tool for operating the tensioner 14. The first, larger set of protrusions 50, 50 are guide ribs canted or angled towards each other as the extend from the front wall 28 towards the open end 26 of the capsule 18. The ends 50a, 50a of the guide ribs also serve to restrict continued rotation of the swivel 22 about hinge points 54 disposed on the exterior surfaces of the top wall 34 and bottom wall 36. The second set of protrusions 52, 52 are retention members aligned generally parallel and opposite sides of the slots 42, 44. As shown in the figures, the second set of protrusions 52, 52 are generally rounded, semi-circular.

Referring to FIG. 11, the top wall 34 and bottom wall 36 are generally squared with a rounded extension 34a, 36a at the open end 26 of the capsule 18. The rounded extensions facilitate smooth rotation of the swivel 22 about hinge points 54, 54. The hinge points 54, 54, as shown herein, are shown as lugs having a squared perimeter supporting a first, second, and third position of the swivel 22 about the hinge points. The hinge points 54, 54 are ramped or cambered to secure the swivel 22 in place when engaging the hinge points 54, 54. As shown in the figures, the top wall 34 and bottom wall 36 are mirror images in configuration.

Referring now to FIGS. 4, 11, the interior surfaces of the first and second sidewalls 38, 40 includes a first and second set of channels 56, 58 configured to receive a first and second set of guides 70, 72 on the nut 32. The guides 70, 72 engaging the first and second sets of channels, 56, 58, prevents rotation of the nut 32 and, in turn secures the portion of the matrix band 12 disposed within the tensioner 14 during operation of the device and restoration of a tooth. The exterior surface of the first sidewall 38 further includes an anchor point 60 configured to engage the matrix band 12 and secure it in place during operation. The anchor point 60 is shown as an oblong or ovalized projection for engaging the anchor holes 90, 90 on the matrix band 12 (FIG. 8) in a press-fit or friction-fit manner.

Turning next to the actuator 20, this component comprises the screw 30 (details in FIGS. 9, 10) and nut 32 (details in FIGS. 4, 13). The screw 30 comprises a head 62 and threaded shaft 64 and may, further includes a collet 66, preferably a barb-type collet, at the junction of the head 62 and threaded shaft 64. The collet 66 is selected to have a larger diameter than the diameter of the bore 28a to secure the screw 30 within the bore 28a. The head 62 has a recess 62a configured to engage with the companion tool. Preferably, the recess has a “double-square” configuration with a second “square” offset 45-degrees from the first “square”, for engaging the companion tool described herein or, alternatively, receiving a standard TORX® or Phillips-head driver.

The nut 32 includes a central channel 68 with threads 68a corresponding to the threaded shaft 64 of the screw 30 to engage the screw in a threaded engagement. The nut 32 further comprises the lateral lugs 46, 48 axially aligned and extending radially outward from a center point of the nut 32. The lateral lugs 46, 48 each include a ramped extension 74, 76 locking the nut 32 into position when the lugs 46, 48 engage the aligned slots 42, 44 of the top wall 34 and bottom wall 36. The first and second sets of guides 70, 72 are axially aligned on opposite sides of the nut 32, with each of the guides perpendicular to the lateral lugs 46, 48. Each set of guides 70, 72 defines a receiving space 70a, 72a enabling passage of the matrix band tail 12b therethrough during operation.

The swivel 22 is generally an open-squared configuration have a base portion 78 and arms 80, 80 extending from opposite ends of the base portion 78. As shown herein, the arms 80, 80 are parallel to each other and perpendicular to the base portion 78. The arms 80, 82 each include hinge hole 84 corresponding in shape and size to the hinge points 54, 54 on the top wall 34 and bottom wall 36. In the embodiment shown herein, the hinge points 54, 54 and hinge holes 84, 84 are substantially squared enabling the swivel 22 to rotate about the hinge points 54, 54 in 90-degree increments, e.g., a first position at 0-degrees to a first axis A1 (FIG. 6) running through the capsule 18, a second position at 90-degrees of rotation, and a third position at 180-degrees of rotation from the first position. This allows the tensioner 14 to be used on either side of a patient's mouth. The base portion 78 further comprises a slot 82 with a top end wider than the opposing, bottom end. The varying width of the slot 82 from end to end enables the matrix band 12 to be ‘looser’ at the top to facilitate a formation replicating natural tooth anatomy.

FIG. 8 shows a circumferential matrix band 12 used in the present inventive system. The matrix band 12 comprises a central portion 86 with a first and second arms 88, 88. Each arm 88, 88 includes an anchor hole 90 at the distal end and a slot 92. During a tooth restoration procedure, the arms are brought together to enable the central portion 86 to form a loop to surround the tooth 20 requiring the restoration and the arms 88, 88 form a tail with anchor holes 90, 90 aligned and the slots 92, 92 aligned. The anchor holes 90, 90 are sized and configured to press fit or friction fit on the anchor point 60 of the first sidewall 38 and slots 92, 92 have a consistent width throughout enabling the threaded shaft 64 of the screw 30 to insert therethrough.

The matrix band 12 and tensioner 14 are mated together as follows. The arms 88, 88 of the matrix band 12 are brought together to form the tail 12b (FIG. 2) that inserts through the slot 82 in the base portion 78 of the swivel 22 and loop 12A (FIG. 2) to engage the tooth T (FIG. 1) being restored. The swivel 22 attaches to the capsule 18 by engaging the hinge holes 84, 84 to the hinge points 54, 54 on the capsule 18. The matrix band tail 12b will overlay at least a portion of the open end 26 of the capsule 18. The anchor holes 90, 90 of the matrix band 12 are press-fit onto the anchor point 60 of the capsule 18 securing the matrix band 12 to the capsule 18. The nut 32 is positioned with cavity 24, the lateral lugs 46, 48 insert within the aligned slots 42, 44 disposed in the top wall 34 and bottom wall 36, and the first second sets of guides 70, 72 engage corresponding sets of channels 56, 58. The matrix band 12 tail extends through the receiving spaces 70a, 72a as the matrix band extends into and out off the cavity 24 of the capsule 18. To complete formation of the actuator 20, the screw 30 inserts through the bore 28a in sidewall 28 until the collet 66 of the threaded shaft 64 presses through to the cavity 24, preventing the screw from disengaging the capsule. The threaded shaft 64 inserts through the slots 92, 92 of matrix band 12 to engage the threaded central channel 68 of the nut 32. As the screw 30 is fixed in position to the capsule 18, rotation of the screw in a first direction will draw the nut 32 up the threaded shaft 64 “tightening” the loop in the matrix band 12 by reducing its circumference. In the configuration described herein, the loop circumference is reduced at 4:1 ratio, i.e., the circumference is reduced by 4 mm for each 1 mm the nut 32 travels up the threaded shaft 64 towards the head 62 of the screw 30. The loop of the matrix band is loosened by reversing the rotation of the screw 30. The configuration of the nut 32, namely, the ramped extensions 70, 72 on the lateral lugs 46, 48 prevent the lugs from fully releasing from the slots 42, 44 in the top wall 34 and bottom wall 36 and prevent the nut 32 from disengaging the capsule 18 as it unscrews from the threaded shaft 64.

Turning now to FIGS. 14-20, embodiments and features of a companion tool, namely, an applicator 100 are shown. The applicator 100 enables the dental professional to operate the actuator 20 of the tensioner 14 resulting the tightening/loosening of the matrix band 12 and easy release of the applicator 100 from the tensioner 14. The applicator 100 is, generally, comprised of a sleeve 102 and driver assembly 104.

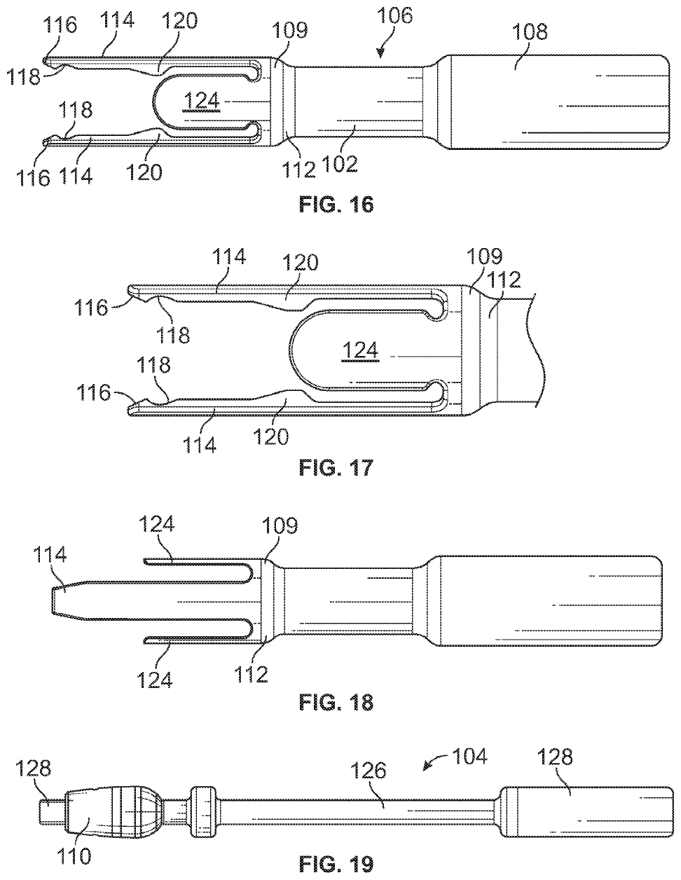

FIGS. 16-18 show the sleeve 102 in detail. The sleeve 102 comprises a generally tube-shaped body 106 having a handle portion 108 and internal channel or chamber (not seen) extending the length of the body 106. Opposite the handle, the body 106 terminates at a gripping assembly 109 configured to house the driver bit 110 (FIGS. 14-16, 20) and releasably receive and secure the tensioner 14 in position. The gripping assembly 109 has a base 112 and, at least, a first set of prongs 114 extending from the base 112. The first set of prongs includes a first and second prong 114, 114 disposed on opposite sides of the base 112 and spaced apart 180-degrees. At the tip of each prong 114, 114 is a ramped retention surface 116 terminating at an adjacent recess 118. The recesses 118, 118 are configured to receive the retention members 52, 52 on the top wall 34 and bottom wall 26 of the capsule 18. Each prong 114, 114 further includes a camming surface 120, 120 configured to engage the tapering sidewalls of the frustoconical driver bit 110. The gripping assembly 108 shown herein includes an optional second set of prongs 124, 124 spaced apart 180-degrees on the base 112 and offset 90-degrees from the prongs 114, 114. The second set of prongs 124, 124 are guide prongs aiding in the proper seating of the driver bit 110 within the gripping assembly 108. The gripping assembly 108 is made from a suitable material allowing flexing and elastic deformation of the prongs 114 and/or the interface of the prongs 114, 114 and base 112. This feature enables the spreading and retracting of the prongs 114, 114. In other embodiments of the device, the first set of prongs in the gripping assembly 108 can include additional prongs spaced equidistant or at inconsistent intervals around the base 112. Suitable modifications to the capsule 18 may be required to secure the gripping assembly 108 to the tensioner 14.

The driver assembly 104 comprises a shaft 126, a handle 128 at a first end of the shaft 126 and the driver bit 110 at the opposite end. The shaft 126 is sized and configured to insert and freely rotate within the internal chamber of the sleeve body 106. The driver bit 110 includes an engagement end 128 configured to be received by the recess 62a on the head 62 of the screw 30 (FIGS. 9, 10). The frustoconical driver bit 110 tapers from the first, shaft end to the engagement end 128. The driver bit 110 is releasable from the shaft 126 to disassemble the driver assembly 104 and separate its components from the sleeve 102. This facilitates suitable cleaning and disinfecting of the applicator 100 for multiple uses. The driver bit 110 shown in FIG. 16 further includes a circumferential channel 130 configured to receive and seat the camming surfaces 120, 120 of the prongs 114, 114. The circumferential channel 130 is positioned on the driver bit 110 to hold the prongs 114, 114 in an open position during easing the mating of the tensioner 14 with the applicator 100.

In operation, the driver assembly 104 is assembled within the sleeve 102 with the driver bit 110 seated within the gripping assembly 108. As the tensioner 14 is being joined with the applicator 100, the guide ribs 50, 50 on the top wall 34 and bottom wall 26 of the capsule 18 guide the first and second prongs 114, 114 into position. Further urging the tensioner and applicator 100 together will force the retention surfaces 116, 116 on the prongs 114, 114 to address the retention members 52, 52 on the top wall 34 and bottom wall 26 of the capsule 18. The prongs 114, 114 are urged open for the retention surfaces 116, 116 to slide over the retention members 52, 52 and seat within the corresponding recesses 118, 118 securing the tensioner 14 and applicator 100 together. Simultaneously, the engagement end 128 of the driver bit 110 seats within the screw head recess 62a.

Application of a first rotation force F1 to the handle 128 of the driver assembly 104 is transferred to the driver bit 110 through the shaft 126 and from the drive bit 110 to the actuator 20 through the screw 30. The first rotation force F1 draws the nut 32 up the threaded shaft 36 resulting in the tightening of the matrix band 12 and reduction in size of the matrix band loop. Applying a second rotation force F2, in a direction opposite the first rotation force F1, to the handle 128 reverses the travel direction of the nut 32 on the threaded shaft 36 causing a loosening of the matrix band 12. During the unscrewing the nut 32, the nut 32 remains seated in the slots 42, 44 secured by the ramped extension 70, 72 on the lateral lugs 46, 48.

The applicator 100 releases the tensioner 14 by applying a lateral, lateral force F3 to the handle 128. The lateral force F3 is transferred to the driver bit 110 through the shaft 126. As the driver bit 110 is urged forward within the gripping assembly 118, its tapered sidewalls apply an opening force F4 to the camming surfaces 120, 120 opening the prongs 114, 114. Opening of the prongs 114, 114 causes the retention surfaces 116, 116 to release from the corresponding recesses 118, 118 enabling the applicator 100 to separate from the tensioner 14.

When the driver bit 110 is in the configuration shown in FIG. 16, the lateral force F3 can be applied when mating the tensioner 14 applicator 100 together. The prongs 114, 114 will remain in an open, expanded position while the camming surfaces 120, 120 seat in the circumferential channel 130. Applying lateral force F4, in the opposite direction of F3, will unseat the camming surfaces 120, 120 and result in the prongs 114, 114 contracting and to engage the tensioner 18.

While the present invention has been described in connection with a specific application, this application is exemplary in nature and is not intended to be limiting on the possible applications of this invention. It will be understood that modifications and variations may be affected without departing from the spirit and scope of the present invention. It will be appreciated that tl1e present disclosure is intended as an exemplification of the invention and is not intended to limit the invention to the specific embodiments illustrated and described. The disclosure is intended to cover, by the appended claims, all such modifications as fall within the scope of the claims.

1. A dental matrix band system for positioning and securing a circumferential matrix band on a tooth in need of restoration, the system comprising:
a circumferential matrix band formable into a loop;
a tensioner releasably attached to an activator, the tensioner adapted to receive the circumferential matrix band and apply to the circumferential matrix band a force generated by the activator to modify the size of the loop;
wherein the tensioner includes a first and a second set of guide ribs each of the sets of guide ribs disposed on opposite sides of the tensioner and positioned to receive one of a first and second prong on the activator and adapted to guide the prong members into position to engage the tensioner,
wherein the tensioner further includes a first and a second set of retention members disposed on opposite sides of the tensioner, each of the first and second sets of retention members adapted to address a corresponding retention surface on each of the first and second prongs and seat in a recess adjacent to each of the retention surfaces, and
wherein the activator generates at least a first lateral force in a first direction, the first lateral force applied to a driver bit and transferred to the first and second prongs to transform the first and second prongs from a first, closed position in secure engagement with the tensioner to a second open position releasing the tensioner from engagement with the activator.

2. The dental matrix band system of claim 1 wherein the driver bit is frustoconical with tapering sides adapted to engage a first camming surface on the first prong and a second camming surface on the second, and wherein continued application of the first lateral force on the driver bit and continued lateral displacement of the driver bit in the direction of the first lateral force transfers to the first and second camming surfaces urging the first and second prongs from the first, closed position to the second, open position.

3. The dental matrix system of claim 2 wherein driver bit further includes a circumferential channel adapted to receiving the first and second camming surfaces, and wherein application of the first lateral force on the driver bit and lateral displacement of the driver bit in the direction of the first force causes the first and second camming surfaces to seat in the circumferential channel and hold the first and second prongs in the second, open position.

4. The dental matrix band system of claim 3 wherein continued application of the first lateral force on the driver bit and continued lateral displacement of the driver bit in the direction of the first lateral force causes the first and second camming surfaces to unseat from the circumferential channel.

5. The dental matrix band system of claim 3 wherein application of a second lateral force on the driver bit, opposite the direction of the first lateral force, causes the first and second camming surfaces to unseat from the circumferential channel and laterally displaces the driver bit in the direction of the second lateral force.

6. The dental matrix band system of claim 2 wherein applying a second lateral force, in a direction opposite the first lateral force, and lateral displacement of the driver bit in the direction of the second lateral force returns the first and second prongs to the first, closed position.

7. The dental matrix band system of claim 1 wherein the driver bit is adapted to engage an actuator of the tensioner when the tensioner is mated with the activator, and the first force generated by the activator and applied to the circumferential matrix band through the tensioner is a first rotational force transferred through the driver bit to the actuator, reducing the dimension of the circumferential matrix band loop.

8. The dental matrix band system of claim 7 wherein a second rotational force generated by the activator, opposite the first rotational force, is transferred through the driver bit to the actuator to increase the dimension of the circumferential matrix band loop.

9. The dental matrix band system of claim 1 wherein the ratio of circumferential matrix band circumference change to lateral displacement in the actuator is 4:1.
